(19) United States
(12) Patent Application Publication
(10) Pub. No.: US 2008/0065728 A1
(43) Pub. Date: Mar. 13, 2008

(54) Method and system for service provider to be compensated for delivering e-mail messages while reducing amount of unsolicited e-mail messages

(75) Inventor: Bertrand Haas, New Haven, CT (US)

Correspondence Address: PITNEY BOWES INC.;35 WATERVIEW DRIVE, P.O. BOX 3000, MSC 26-22, SHELTON, CT, 06484-8000, US

(73) Assignee: Pitney Bowes Incorporated, Stamford, CT (US)

(21) Appl. No.: 11/517,855

(22) Filed: Sep. 8, 2006

(51) Int. Cl. G06F 15/16

(52) U.S. Cl. 709/206; 709/207

(57) ABSTRACT

Methods and systems for sending e-mail messages are provided. A sender of an e-mail pays a sending fee to the service provider for each e-mail sent. Each e-mail message includes a link to additional information. If the recipient desires to obtain the additional information, the recipient will request the additional information utilizing the link. The service provider, in response to the request by the recipient, sends the additional information to the recipient. The service provider refunds the sending fee, or some portion thereof, to the sender for each e-mail message for which the recipient requests the additional information, while retaining the sending fee for those e-mails for which the additional information was not requested.

### FIELD OF THE INVENTION

The invention disclosed herein relates generally to information delivery via computer networks, and more particularly to a method and system for a service provider to be compensated for delivering e-mail messages that will reduce the amount of unsolicited e-mail messages sent via computer networks.

### BACKGROUND OF THE INVENTION

The growth of the Internet has made e-mail a popular communication method for many people along with many commercial businesses. Such businesses can utilize e-mail messages for advertising purposes by mass e-mailing advertising messages to large numbers of e-mail addresses. Unfortunately, many people find the practice of mass e-mailing, also referred to as spamming, to be both aggravating and time consuming, as it can result in receipt of numerous unwanted e-mail messages every day. In many instances, the recipient may need to actually open the e-mail message and review it before determining that it is an unwanted solicitation and deleting it, thereby wasting valuable time. In addition, if the recipient's Internet Service Provider (ISP) limits the amount of e-mail that can be accepted or stored, unwanted e-mail messages can prevent a recipient from actually receiving e-mail messages that are important or desired.

Numerous attempts have been made to reduce the amount of spam, including the filtering of unsolicited e-mails by only accepting e-mails from authorized addresses or rejecting e-mails from known spammers. This approach, however, relies on the accuracy of the respective lists and must be continually updated to be effective. Additionally, sophisticated spammers have developed numerous methods to defeat such filters, thereby rendering them ineffective.

Another problem created by spamming is an increase in the amount of network message traffic, thereby potentially adversely impacting system performance of the network. In many situations, the ISP is not compensated based on the amount of e-mail messages delivered, thus allowing spammers to send unrestricted amounts of e-mail. Attempts to charge e-mail senders based on the amount of e-mail messages delivered have been met with considerable resistance and generally found to be unworkable, as such charges do not discriminate between spammers and legitimate e-mailers. In particular, many legitimate businesses and organizations, including non-profit organizations, public interest organizations and the like, would still be charged for sending e-mails that recipients actually desired to receive.

Thus, there exists a need for a method and system for selectively compensating service providers for delivering unsolicited and/or unwanted e-mail messages that will help to reduce the amount of unsolicited and/or unwanted e-mail messages being sent.

### SUMMARY OF THE INVENTION

The present invention alleviates the problems associated with the prior art and provides methods and systems that selectively compensate service providers for delivering unsolicited and/or unwanted e-mail messages while reducing the amount of unsolicited and/or unwanted e-mail messages being sent.

In accordance with embodiments of the present invention, a sender desiring to send e-mail messages provides a service provider with the e-mail messages to be sent to recipients. Each e-mail message consists of two parts—a first data part that includes some information intended to entice the recipient to request additional information that the recipient would want to read if the recipient deemed the e-mail message to be of some value, and a second data part comprising the additional information such as, for example, important information (dates, addresses, etc.), a coupon, a music single, a short video, product images, etc. The service provider temporarily stores the second data part, and sends the first data part to the desired recipients in an e-mail message. The sender pays a sending fee to the service provider for each e-mail including the first data part sent to a recipient. Each e-mail message sent to the desired recipients includes a link for the recipient to select if the recipient desires to read the additional information. By selecting, or clicking on, the link provided in the e-mail message, an automatic reply will be sent to the service provider that identifies the recipient and indicates that the recipient has found the e-mail message to be of some value, and desires to obtain the second data part associated with the first data part, i.e., the additional information.

The service provider then retrieves the additional information associated with the first data part and sends it to the recipient that requested it. The service provider refunds the sending fee, or some portion thereof, to the sender for each e-mail message for which a recipient requests the additional information, while retaining the sending fee for those e-mails for which the additional information was not requested. Optionally, the service provider can also provide to the sender the e-mail address for those recipients that requested the additional information, thereby providing valuable marketing information to the sender for possible future e-mails. Thus, a sender will be motivated to only send e-mails that are deemed valuable and wanted by a recipient (as determined by the recipient requesting the additional information), as the sender will be refunded the sending fee for such e-mails. As a result, recipients will receive reduced amounts of unwanted and/or unsolicited e-mails. Additionally, the service provider will be compensated for those e-mails for which the additional information is not requested. The overall result will be a reduction in the amount of unsolicited and/or unwanted e-mail messages being sent and service providers being compensated only for delivering unsolicited and/or unwanted e-mail messages.

Therefore, it should now be apparent that the invention substantially achieves all the above aspects and advantages. Additional aspects and advantages of the invention will be set forth in the description that follows, and in part will be obvious from the description, or may be learned by practice of the invention. Moreover, the aspects and advantages of the invention may be realized and obtained by means of the instrumentalities and combinations particularly pointed out in the appended claims.

### DESCRIPTION OF THE DRAWINGS

The accompanying drawings illustrate a presently preferred embodiment of the invention, and together with the general description given above and the detailed description given below, serve to explain the principles of the invention. As shown throughout the drawings, like reference numerals designate like or corresponding parts.

FIG. 1 illustrates in block diagram form a system according to an embodiment of the present invention; and

FIG. 2 illustrates in flow diagram form the operation of the system of FIG. 1 according to an embodiment of the present invention.

### DETAILED DESCRIPTION OF THE PRESENT INVENTION

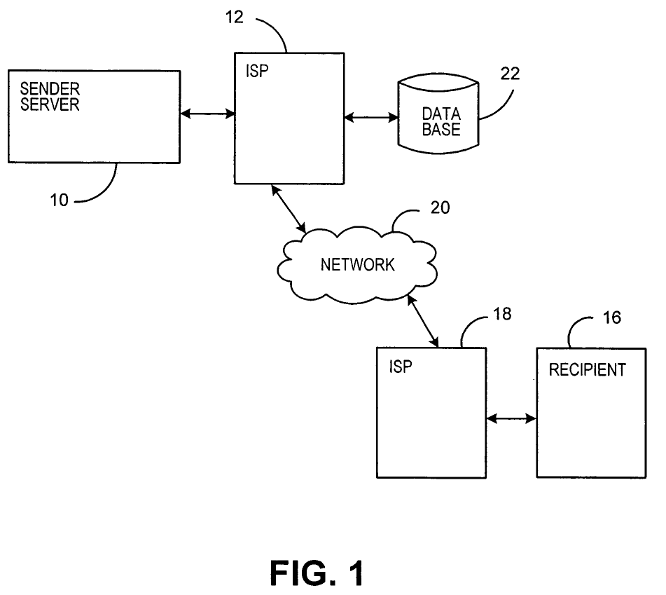

In describing the present invention, reference is made to the drawings, where there is seen in FIG. 1 in block diagram form an e-mail system according to an embodiment of the present invention. The system includes a sender server 10 that is communicatively coupled to an Internet Service Provider (ISP) 12 via any conventional means, including, for example, via telephone line, broadband connection, etc. Sender server 10 may be any type of processor based system. ISP 12 provides connection services for the sender server 10 to a network 20, such as, for example, the Internet, and also provides services for the sender server 10 to send e-mail messages via the network 20. ISP 12 is coupled to a database 22 which is used to store information as described below. Database 22 may be separate from or internal to ISP 12. Alternatively, any type of suitable memory device can be utilized by ISP 12. A recipient 16 is coupled to an ISP 18, which may or may not be the same as ISP 12. Recipient 16 may be any type of processing system, such as, for example, a personal computer. ISP 18 provides the recipient 16 with access to network 20, and also manages receipt and delivery of e-mail messages to/from recipient 16 based on an e-mail address that uniquely identifies the recipient 16. The concept of service providers and e-mail systems are well known in the art and need not be described in further detail.

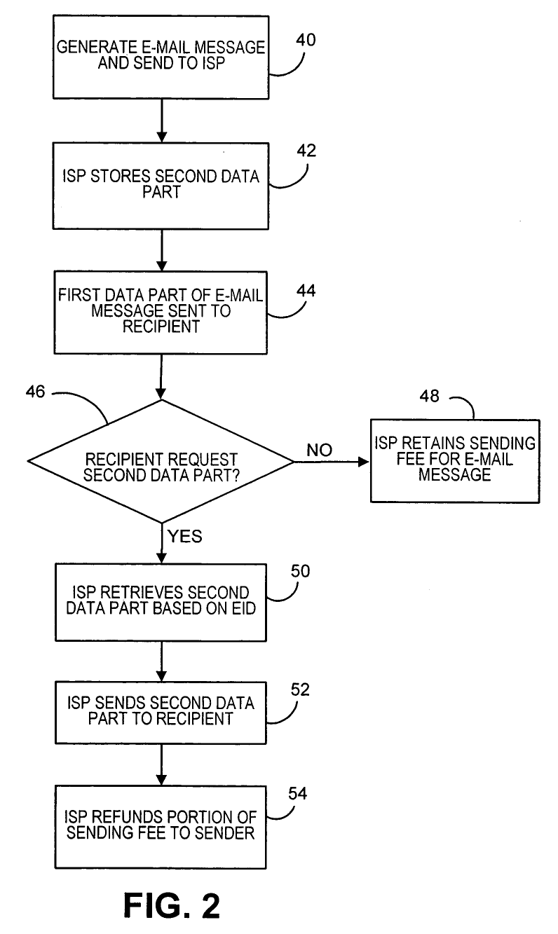

Referring now to FIG. 2, there is illustrated in flow diagram form the operation of the system of FIG. 1 for sending e-mail according to an embodiment of the present invention. Suppose, for example, that a sender, using the sender server 10, desires to send an e-mail to a recipient 16. While the present description will be given with respect to a single e-mail to a single recipient, it should be understood that similar processing applies for any number of e-mail messages to any number of recipients. In step 40, an e-mail message to the recipient 16 is generated by, for example, the sender server 10 and sent to the ISP 12. The e-mail message includes a first data part that includes some information intended to entice the recipient 16 to request additional information that the recipient 16 would want to read if the recipient 16 deemed the e-mail message to be of some value. The e-mail message further includes a second data part comprising the additional information such as, for example, a coupon, a music single, a short video, product images, etc. or other types of important information, e.g., dates, addresses, or the like.

In step 42, the ISP 12 stores the second data part of the e-mail message in the database 22 (or any other suitable memory device). Preferably, the second data part is stored along with additional information that the ISP 12 will use to identify the second data part. Such additional information can include, for example, an identification of the sender or sender server 10, the e-mail address of the recipient 16, a date of the e-mail message, and a unique identification number for each e-mail (referred to hereinafter as EID). The use of the EID allows the ISP 12 to distinguish between different e-mails sent to the same recipient on the same date. The EID may be randomly generated. Optionally, the EID could be a pointer that points to a second data part if the second data part is common to several recipients. In this case, the ISP 12 needs to only store the second data part once, thereby utilizing less memory space that would be required if the ISP 12 stored the second data part separately for every e-mail message. The ISP 12 also preferably computes an expiration date for the second data part after which the ISP 12 can delete the second data part from the database 22.

In step 44, the first data part of the e-mail message is sent to the recipient 16. The ISP 12 includes an embedded reply link in the e-mail message that includes the first data part that, if accessed by the recipient 16, will indicate to the ISP 12 that the recipient 16 desires to obtain the second data part. According to the present invention, the sender pays the ISP 12 a sending fee for each e-mail message sent by the sender server 10 and delivered to a recipient via the ISP 12. The ISP 12 will reduce, or refund, some portion, or all, of the sending fee for those e-mail messages sent by the sender server 10 that the recipient 16 has deemed to be of value, while maintaining the full amount of the sending fee that the recipient 16 has not deemed to be of value. Thus, there is a financial incentive for senders to only send e-mails that recipients will deem valuable. An e-mail is deemed to be valuable to a recipient 16 if the recipient 16 desires to obtain the entire e-mail message, including the second data portion. Thus, it is in best interest of the sender to ensure that the second data portion includes some information that the recipient will want to receive.

Upon receipt of the e-mail message including the first data part, the recipient 16 will determine whether or not to obtain the second data part based on the recipient's 16 level of interest. If the recipient 16 desires to obtain the full e-mail message, i.e., both the first and the second data parts, the recipient 16 can request the second data part from the ISP 12 utilizing the embedded reply link in the e-mail message that contains only the first data part. By clicking on the embedded reply link, an automatic reply will be sent to the ISP 12 that identifies the recipient 16 and provides the EID. Optionally, the embedded reply link can also be used to automatically send a notice to the sender server 10 when the recipient 16 requests the second data part from the ISP 12. Through use of these automatic replies, the sender will know exactly for which e-mail messages the full sending fee should not be paid, thereby allowing the sender to reconcile accounting with the ISP 12.

In step 46, the ISP 12 continuously monitors to determine if the recipient 16 of the e-mail message has requested the second data part for the e-mail message. Optionally, some type of time frame can be agreed upon by the sender and ISP 12 as to the time allowed for a recipient 16 to request the second data part (referred to above as the expiration date). If the recipient 16 has not requested the second data part by the expiration date, then in step 48 the ISP 12 will retain all of the sending fee the sender paid to the ISP 12 for that e-mail message. Alternatively, if the ISP 12 bills the sender in a post-payment billing type of payment system, the IPS 12 will bill the sender for the full amount of the sending fee for that e-mail message.

If in step 46 it is determined that the recipient 16 has requested the second data part for an e-mail message sent by the sender server 10, then in step 50 the ISP 12 will retrieve the appropriate second data part, based on the EID returned in the automatic reply. In step 52 the ISP 12 sends the second data part of the e-mail message to the recipient 16. In step 54, the ISP 12 refunds some portion, or all, of the sending fee to the sender for that e-mail message. If a post-payment billing system is utilized, then the ISP 12 will reduce the amount of the sending fee for delivering that e-mail message by some amount, e.g., the entire amount or some portion thereof, by removing the sending fee or reducing the sending fee for that e-mail message before the bill is sent to the sender. Optionally, the ISP 12 can also provide the e-mail addresses for those recipients that did request the second data part to the sender server 10, thereby providing the sender with valuable marketing information for future e-mail messages. Such marketing information could include, for example, which recipients found e-mail messages relating to a specific topic valuable, which were found not valuable, etc., for future targeted advertising.

Thus, the present invention will selectively compensate the service provider for delivering unsolicited and/or unwanted e-mail messages, while acting to reduce the amount of unsolicited and/or unwanted e-mail messages being sent. Senders of e-mail messages will be motivated to only send e-mails that are deemed valuable and wanted by a recipient, as the sender will be refunded the sending fee (or some portion thereof) for such e-mails. For those e-mail messages not deemed valuable, the sender will have to pay the full sending fee. Thus, a sender will have to pay a fee for sending an e-mail message that is not deemed valuable by a recipient, while paying a lesser fee (which may be zero) for sending an e-mail message that is deemed valuable by a recipient. As a result, senders are much less likely to engage in mass e-mailing campaigns (spamming), and therefore recipients will receive reduced amounts of unwanted and/or unsolicited e-mails. Additionally, the service provider will be compensated for those e-mails for which the second data part is not requested. The overall result will be a reduction in the amount of unsolicited and/or unwanted e-mail messages being sent and service providers being compensated only for delivering unsolicited and/or unwanted e-mail messages.

While preferred embodiments of the invention have been described and illustrated above, it should be understood that these are exemplary of the invention and are not to be considered as limiting. Additions, deletions, substitutions, and other modifications can be made without departing from the spirit or scope of the present invention. Accordingly, the invention is not to be considered as limited by the foregoing description.

What is claimed is:

1. A method for a service provider to deliver an e-mail message for a sender, the method comprising:
delivering a first data part of the e-mail message to an e-mail address for a recipient;
storing a second data part of the e-mail message;
charging the sender a sending fee for delivery of the first data part of the e-mail message to the e-mail address for the recipient;
determining if the recipient has requested the second data part of the e-mail message; and
if the recipient has requested the second data part of the e-mail message, retrieving and delivering the second data part of the e-mail message to the e-mail address for the recipient and reducing the sending fee to the sender.

2. The method according to claim 1, wherein the first data part includes a link for the recipient to request the second data part of the e-mail message, and determining if the recipient has requested the second data part further comprises:
determining if the recipient has clicked on the link to request the second data part of the e-mail message.

3. The method according to claim 1, wherein storing the second data part of the e-mail message further comprises:
associating the second data part with a unique identification number and storing the second data part and the unique identification number.

4. The method according to claim 3, wherein a request by the recipient to receive the second data part of the e-mail message includes the unique identification number associated with the second data part, and retrieving the second data part of the e-mail message further comprises:
using the unique identification number to retrieve the second data part.

5. The method according to claim 1, further comprising:
providing notification to the sender that the recipient has requested the second data part of the e-mail message.

6. The method according to claim 1, wherein reducing the sending fee further comprises:
refunding at least a portion of the sending fee to the sender.

7. The method according to claim 1, determining if the recipient has requested the second portion of the e-mail message further comprises:
determining if the recipient has requested the second portion of the e-mail message within a predetermined time period.

8. The method according to claim 1, wherein charging the sender a sending fee for delivery of the e-mail message further comprises:
preparing a bill for sending to the sender for delivery of the e-mail message.

9. The method according to claim 8, wherein reducing the sending fee further comprises:
reducing the sending fee on the bill prepared for the sender.

10. A method for a service provider to deliver and be compensated for delivering an e-mail message for a sender, the method comprising:
delivering a first portion of the e-mail message for the sender to an e-mail address for a recipient, the first portion of the e-mail message including a link for the recipient to request a second portion of the e-mail message;
charging the sender a first fee for delivery of the e-mail message to the e-mail address for the recipient if the recipient has not requested the second portion of the e-mail message within a predetermined time period; and
charging the sender a second fee for delivery of the e-mail message to the e-mail address for the recipient if the recipient has requested the second portion of the e-mail message within the predetermined time period, the second fee being less than the first fee.

11. The method according to claim 10, wherein the second fee is zero.
